(19) United States
(12) Patent Application Publication
(10) Pub. No.: US 2026/0010334 A1
(43) Pub. Date: Jan. 8, 2026

(54) ADJUSTING AUDIO OUTPUT IN A VEHICLE

(71) Applicant: Motorola Mobility LLC, Chicago, IL (US)

(72) Inventors: Amit Kumar Agrawal, Bangalore (IN); Panduranga Reddy Pailla, Bangalore (IN); Vijayprakash Idlur, Bangalore (IN)

(73) Assignee: Motorola Mobility LLC, Chicago, IL (US)

(21) Appl. No.: 18/766,618

(22) Filed: Jul. 8, 2024

(51) Int. Cl. G06F 3/16; H04R 3/12; H04S 7/00

(52) U.S. Cl. CPC G06F 3/165; G06F 3/167; H04R 3/12; H04S 7/303; H04R 2430/01

(57) ABSTRACT

In aspects of adjusting audio output in a vehicle, a vehicle audio system implements an audio playback manager that detects a location of a first person in the vehicle, the first person located in proximity of a first speaker device configured for audio output. The audio playback manager also detects an additional location of a second person in the vehicle, the second person located in proximity of a second speaker device configured for the audio output. The audio playback manager determines a preference for the first person related to the audio output and an additional preference for the second person related to the audio output. Based on the preference of the first person or the additional preference of the second person, the audio playback manager adjusts a volume of at least one of the first speaker device or the second speaker device.

### BACKGROUND

Speaker devices may be placed throughout a vehicle's interior to deliver immersive surround-sound for audio playback to passengers inside the vehicle. The speaker devices, for example, may be positioned in doors, a dashboard, a rear deck, headrests, or other positions inside the vehicle to provide a balanced sound system when used together. This results in an enjoyable driving experience, as the audio playback helps obscure unwanted ambient noise, such as traffic or engine noise. Examples of the audio playback include music, podcasts, call audio, audio books, or other forms of audio for enjoyment inside the vehicle.

### BRIEF DESCRIPTION OF THE DRAWINGS

Implementations of the techniques for adjusting audio output in a vehicle are described with reference to the following Figures. The same numbers may be used throughout to reference like features and components shown in the Figures.

FIG. 1 illustrates an example system for adjusting audio output in a vehicle in accordance with one or more implementations as described herein.

FIG. 2 further illustrates an example of adjusting audio output in a vehicle in accordance with one or more implementations as described herein.

FIG. 3 further illustrates an example of adjusting audio output in a vehicle by lowering a volume of a speaker device based on a preference related to the audio output in accordance with one or more implementations as described herein.

FIG. 4 further illustrates an example of adjusting audio output in a vehicle by increasing a volume of a speaker device based on a preference related to the audio output in accordance with one or more implementations as described herein.

FIG. 5 further illustrates an example of adjusting audio output in a vehicle by lowering a volume of a speaker device based on detecting whether the person is asleep in accordance with one or more implementations as described herein.

FIGS. 6-8 illustrate example methods for adjusting audio output in a vehicle in accordance with one or more implementations of the techniques described herein.

FIG. 9 illustrates various components of an example device that may be used to implement the techniques for adjusting audio output in a vehicle as described herein.

### DETAILED DESCRIPTION

Implementations of the techniques for adjusting audio output in a vehicle may be implemented as described herein. A vehicle is equipped with vehicle-to-device communication that enables the vehicle to connect and interact with other devices, such as a mobile device. The mobile device, such as any type of a wireless device, media device, mobile phone, flip phone, client device, tablet, computing, communication, entertainment, gaming, media playback, and/or any other type of computing and/or electronic device, or a system of any combination of such devices, may be configured to perform techniques for adjusting audio output in a vehicle as described herein. In one or more implementations, the vehicle and/or the mobile device includes an audio playback manager, which can be used to implement aspects of the techniques described herein.

Vehicles are commonly equipped with multiple speaker devices, which are positioned at various locations around the interior of a vehicle. The purpose of this is to provide a sense of surround-sound for audio playback inside the vehicle. For instance, the speaker devices may be configured to play a variety of audio selected using a mobile device and casted to the speaker devices for playback or selected using an in-vehicle “infotainment” device. Examples of the audio playback include music, podcasts, call audio, audio books, or other forms of audio available for enjoyment inside the vehicle.

However, people in the vehicle often have different preferences related to the audio that is selected and played back inside the vehicle. One person in the vehicle may enjoy country music and dislike rap music, while another person in the vehicle may enjoy rap music but dislike country music. This leads to disagreements over which type of audio to play in the vehicle. Additionally, even if common ground is found for a type of audio to play, the people may disagree on a volume for the audio. For instance, one person may desire to sleep in the vehicle and not be kept awake by loud music.

Conventional solutions fail to address these challenges. For example, people inside the vehicle may listen to their own audio using earbuds or headphones. However, this prevents the people in the vehicle from having a conversation, as the earbuds or headphones block out sound from another person speaking. Additionally, it is unsafe for a driver of a vehicle to wear earbuds or headphones, as it may prevent the driver from hearing important external sounds, such as sirens from emergency vehicles or warning horns from other vehicles.

Techniques and systems are described for adjusting audio output in a vehicle, such as based on the respective locations of occupants in the vehicle, which addresses these challenges. This involves individually personalizing volumes for specific speaker devices directed toward each separate person in the vehicle based on their own preferences related to the audio output. For example, a country music song is playing in the vehicle. A volume of a speaker device directed toward a person who enjoys country music is raised, while a volume of a speaker device directed toward a person who dislikes country music is lowered. This facilitates a better user experience inside the vehicle, as different types of audio output may be cycled for playback, but the people in the vehicle only listen to the types of audio output that they enjoy. These techniques are also an improvement over the conventional solutions, thereby eliminating the need for earbuds or headphones to listen to the audio output at a personalized volume. Additionally, people may also sleep in the vehicle because a volume of a speaker device directed toward a person who is sleeping may also be lowered.

A vehicle and/or a connected device (e.g., a mobile device) implements the audio playback manager. In aspects of the described techniques, to determine audio preferences for the people in the vehicle, the audio playback manager first identifies the people in the vehicle. To do this, the audio playback manager uses input from a camera system or a microphone system to detect a location of a first person in the vehicle and a location of a second person in the vehicle. For instance, the audio playback manager receives input from the camera device, including images captured inside the vehicle and performs facial recognition to identify the first person and at least another person. Alternatively, the audio playback manager receives captured voice audio from the microphone inside the vehicle and performs voice recognition to identify the first person and the second person based on determined origin locations of the voice audio inside the vehicle.

After detecting the location of the first person in the vehicle and the location of the second person in the vehicle, the audio playback manager determines which speaker devices correspond to the first person, the second person, or both the first and the second person (i.e., a combination of people inside the vehicle). The vehicle includes multiple speaker devices positioned inside the vehicle that are configurable for audio playback at individually adjusted volumes. For example, a first speaker device is positioned in or near a headrest of a seat of the first person, and a second speaker device is positioned in or near a headrest of a second person. The location of the first person is therefore closer to the first speaker device than the second speaker device, and the location of the second person is located closer to the second speaker device than the first speaker device. Accordingly, the first person primarily hears the audio output coming from the first speaker device, and the second person primarily hears the audio output coming from the second speaker device.

In this example, the audio playback manager also identifies the audio output being output by the first speaker device and the second speaker device. The audio playback manager identifies the audio output based on metadata, labels, or other characteristics of the audio output. The identity of the audio output may be any type, classification, genre, artist, band, producer, theme, narrator, lyrics, audience, or other aspect of the audio output.

Because the first person and the second person may not both want to listen to the audio output, the audio playback manager determines a preference for the first person related to the audio output and an additional preference for the second person related to the audio output. The audio playback manager may determine the preferences, for example, by accessing a database of audio preferences, including the preferences of the first person and the second person. The database of audio preferences, for instance, may be formed based on inferences by a machine learning model trained to determine the audio preferences based on prior audio consumption history, or may be formed based on manual input of the audio preferences. The audio preferences may relate to any aspect of an identity of a type of audio output. For example, the preference for the first person related to the audio content indicates that the first person enjoys country music, while the preference for the second person related to the audio content indicates that the second person does not enjoy country music.

The audio playback manager then adjusts a volume of the first speaker device and/or the second speaker device based on the preference for the first person or the additional preference for the second person. In this example, because the audio playback manager determines that the audio output in the vehicle is country music, and based on the preference for the first person related to the audio content indicates that the first person enjoys country music, while the preference for the second person related to the audio content indicates that the second person does not enjoy country music, the audio playback manager raises a volume of the first speaker device corresponding to the first person, while lowering a volume of the second speaker device corresponding to the second person.

In some example implementations, the audio playback manager may also be configured to detect that a person is sleeping inside the vehicle and adjust a volume of a speaker device to avoid disturbing the person. For example, the audio playback manager detects that the second person is sleeping based on captured images or video of the second person based on the camera input. In response, the audio playback system lowers the volume of the second speaker device corresponding to the second person. This prevents the second person from being disturbed by the audio output in the vehicle.

While features and concepts of the described techniques for adjusting audio output in a vehicle is implemented in any number of different devices, systems, environments, and/or configurations, implementations of the techniques for adjusting audio output in a vehicle are described in the context of the following example devices, systems, and methods.

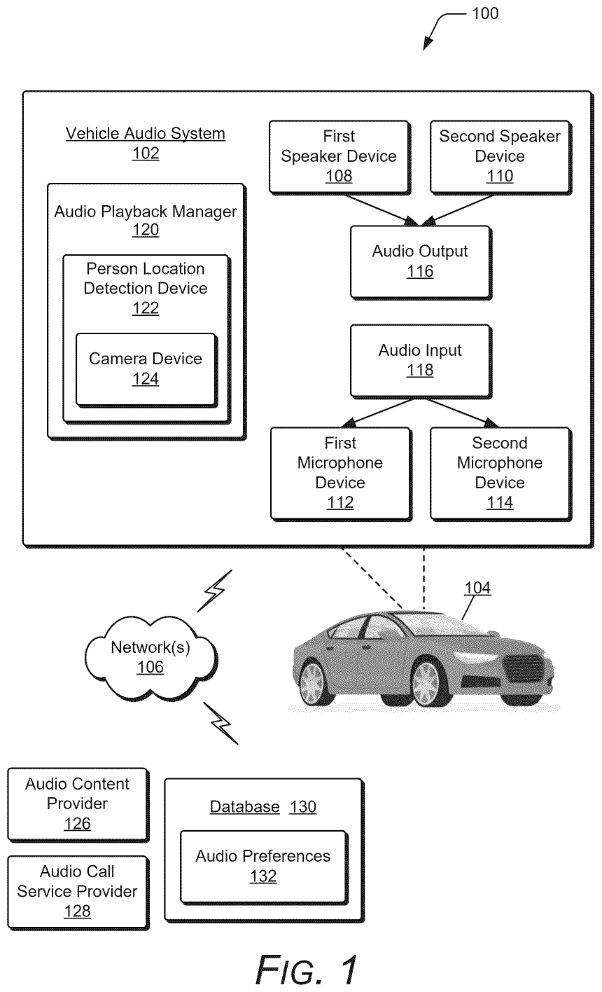

FIG. 1 illustrates an example system 100 for adjusting audio output in a vehicle, as described herein. The system 100 includes a vehicle audio system 102 implemented in a vehicle 104, and a communication network 106. The vehicle audio system 102 includes a speaker system that includes at least a first speaker device 108 and a second speaker device 110, as well as a microphone system that includes at least a first microphone device 112 and a second microphone device 114. The first speaker device 108 and the second speaker device 110 are configured to playback audio output 116 inside the vehicle 104. The audio output 116, for example, may include music, audio from a voice call, a podcast, radio, an audio book, or other type of audio received for playback by the vehicle audio system 102. The first microphone device 112 and the second microphone device 114 are configured to receive audio input 118 from inside the vehicle 104. The audio input 118, for example, includes voice audio or ambient noise from inside the vehicle 104. In some examples, the vehicle audio system 102 may also include any type of a wireless device in communication with the vehicle 104, including a mobile device, mobile phone, flip phone, client device, companion device, tablet, computing device, communication device, entertainment device, gaming device, media playback device, any other type of computing and/or electronic device.

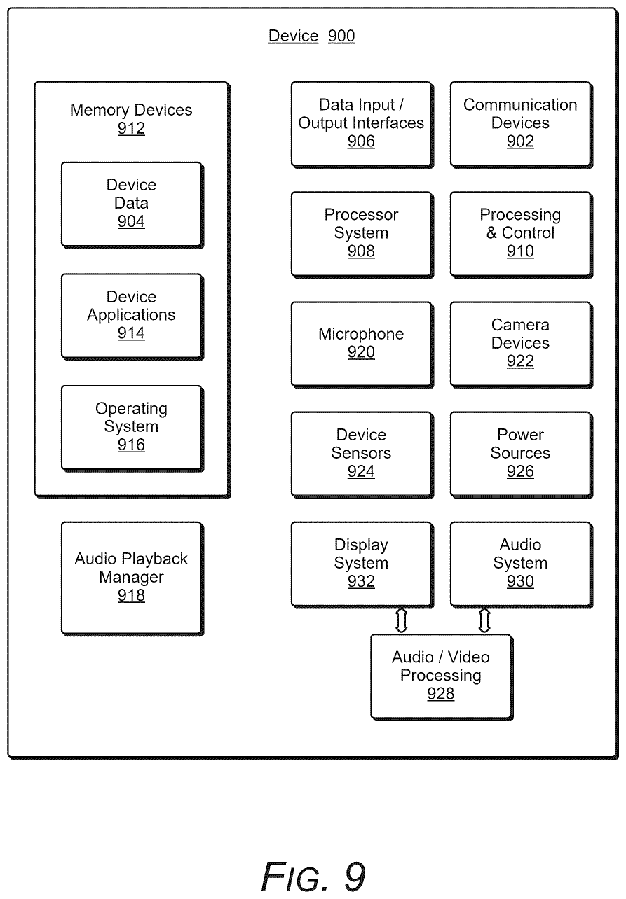

The vehicle audio system 102 can be implemented with various components, such as a processor system and memory, as well as any number and combination of different components as further described with reference to the example device shown in FIG. 9. In implementations, the vehicle audio system 102 may include various radios for wireless communication with other devices. For example, the system and devices can include a Bluetooth (BT) and/or Bluetooth Low Energy (BLE) transceiver, as well as a near field communication (NFC) transceiver. In some cases, the system and devices include at least one of a Wi-Fi radio, a cellular radio, a global positioning satellite (GPS) radio, or any available type of device communication interface.

In some implementations, the vehicle, the devices, applications, modules, servers, and/or services described herein communicate via the communication network 106, such as for data communication with the vehicle audio system 102. The communication network 106 includes a wired and/or a wireless network. The communication network 106 is implemented using any type of network topology and/or communication protocol, and is represented or otherwise implemented as a combination of two or more networks, to include IP-based networks, cellular networks, and/or the Internet. The communication network 106 includes mobile operator networks that are managed by a mobile network operator and/or other network operators, such as a communication service provider, mobile phone provider, and/or Internet service provider. In one or more examples, the vehicle audio system 102 is capable of interconnecting and interfacing with other devices and/or networks, such as the communication network 106 via wireless and/or wired connectivity.

In the example system 100 for adjusting audio output in a vehicle, the vehicle audio system 102 implements an audio playback manager 120. As shown in this example, the audio playback manager 120 represents functionality (e.g., logic, software, and/or hardware) enabling aspects of the described techniques for adjusting audio output in a vehicle. The audio playback manager 120 can be implemented as computer instructions stored on computer-readable storage media and can be executed by a processor system of the vehicle audio system 102. Alternatively, or in addition, the audio playback manager 120 can be implemented at least partially in hardware of the device.

In one or more implementations, the audio playback manager 120 includes independent processing, memory, and/or logic components functioning as a computing and/or electronic device integrated with the vehicle audio system 102. Alternatively, or in addition, the audio playback manager 120 can be implemented in software, in hardware, or as a combination of software and hardware components. In this example, the audio playback manager 120 is implemented as a software application or module, such as executable software instructions (e.g., computer-executable instructions) that are executable with a processor system of the vehicle audio system 102 to implement the techniques and features described herein. As a software application or module, the audio playback manager 120 can be stored on computer-readable storage memory (e.g., memory of a device), or in any other suitable memory device or electronic data storage implemented with the controller. Alternatively or in addition, the audio playback manager 120 is implemented in firmware and/or at least partially in computer hardware. For example, at least part of the audio playback manager 120 is executable by a computer processor, and/or at least part of the content manager is implemented in logic circuitry.

In this example system 100, the audio playback manager 120 detects a location of a first person in the vehicle 104 and a location of a second person in the vehicle 104. For example, the vehicle 104 may include multiple seats inside the vehicle 104, where multiple people may be seated for a duration of a ride in the vehicle 104. To detect the location of the first person in the vehicle 104 and the location of the second person in the vehicle 104, the vehicle audio system 102 includes a person location detection device 122, which may include a camera device 124. The camera device 124, for instance, may be integrated in a rearview mirror to capture images of an internal passenger area of the vehicle 104. The person location detection device 122 may use the camera device 124, for instance, to capture images inside the vehicle 104 to perform facial recognition to identify the first person and the second person. In another example implementation, the person location detection device 122 may receive weight sensor data from weight sensors in seat in the vehicle 104 to detect people seated in the vehicle 104.

In another example implementation, the audio playback manager 120 detects the location of the first person in the vehicle 104 and the location of the second person in the vehicle 104 based on voice recognition. For instance, the first microphone device 112 and the second microphone device 114 receive the audio input 118, which may include spoken audio from people in the vehicle 104, such as voice commands or ambient conversational audio. The audio playback manager 120 compares the audio input 118 to known voice characteristics for particular people and matches an identified voice with a particular speaker device. In an example, for instance, the first person is speaking in the vehicle 104. Because the first microphone device 112 receives the audio input 118 at a higher volume than the second microphone device 114, the audio playback manager 120 determines that the first person is located closer to the first microphone device 112. Based on this and a predetermined map of the vehicle 104, the audio playback manager 120 determines the location of the first person in the vehicle 104 and the location of the second person in the vehicle 104.

After detecting the location of the first person in the vehicle 104 and the location of the second person in the vehicle 104, the vehicle audio system 102 determines which speaker devices correspond to the first person or the second person. For example, the location of the first person is in proximity of the first speaker device 108, and the location of the second person is in proximity of the second speaker device 110. The location of the first person is located closer to the first speaker device 108 than the second speaker device 110, and the location of the second person is located closer to the second speaker device 110 than the first speaker device 108. In other words, the first person primarily hears the audio output 116 coming from the first speaker device 108, and the second person primarily hears the audio output 116 coming from the second speaker device 110. This is because the first speaker device 108 may be configured to output audio nearby the first person's head, and the second speaker device 110 may be configured to output audio nearby the second person's head.

In this example, the audio playback manager 120 also identifies the audio output 116 being output by the first speaker device 108 and the second speaker device 110. The audio output 116, for example, may be provided by an audio content provider 126 accessible via the communication network 106. The audio playback manager 120 identifies the audio output 116 based on any type, classification, genre, artist, band, producer, theme, narrator, lyrics, audience, or other aspect of the audio output 116. Additionally or alternatively, the audio playback manager 120 identifies that an audio call is in session inside the vehicle 104, hosted by an audio call service provider 128 accessible via the communication network 106.

Because the first person and the second person may not both want to listen to the audio output 116, the audio playback manager 120 determines a preference for the first person related to the audio output 116 and an additional preference for the second person related to the audio output 116. The audio playback manager 120 may determine the preferences, for example, based on a database 130 of audio preferences 132 corresponding to the first person and the second person, which is accessible via the communication network 106 or saved directly at the vehicle audio system 102. In some examples, the preferences relate to any type, classification, genre, artist, band, producer, theme, narrator, lyrics, audience, or other aspect of the audio output 116. For example, the preference for the first person related to the audio content indicates that the first person enjoys country music, while the preference for the second person related to the audio content indicates that the second person does not enjoy country music.

The audio playback manager 120 then adjusts a volume of the first speaker device 108 or the second speaker device 110 based on the preference for the first person or the additional preference for the second person. In this example, because the audio playback manager 120 determines that the audio output 116 in the vehicle 104 is country music, and based on the preference for the first person related to the audio content indicates that the first person enjoys country music, while the preference for the second person related to the audio content indicates that the second person does not enjoy country music, the audio playback manager 120 raises a volume of the first speaker device 108 corresponding to the first person, while lowering a volume of the second speaker device 110 corresponding to the second person. This way, the first person is able to listen to music they like, while the second person does not have to listen to music they dislike.

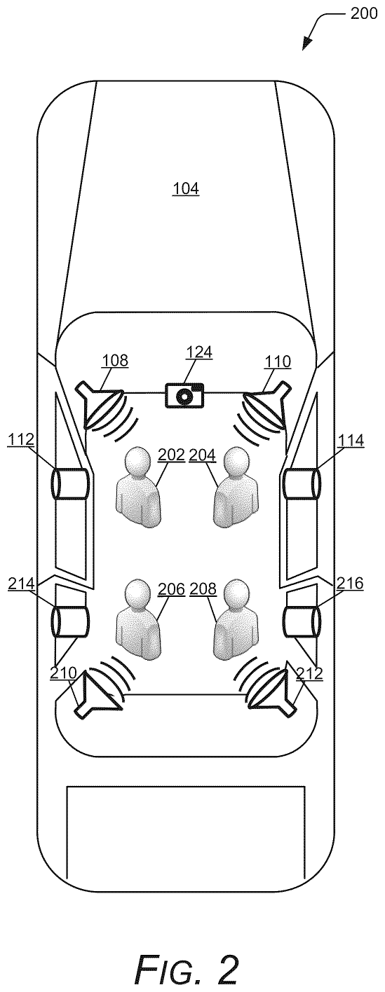

FIG. 2 illustrates example 200 of adjusting audio output in a vehicle. In this example 200, the audio playback manager 120 detects locations of a first person 202, a second person 204, a third person 206, and a fourth person 208 in a vehicle 104. For example, the first person 202, the second person 204, the third person 206, and the fourth person 208 are seated in different seats of vehicle 104. Although this example involves four people, the vehicle 104 may include any number of people in other examples.

To detect the locations of the first person 202, the second person 204, the third person 206, and the fourth person 208, the audio playback manager 120 may employ a person location detection device 122, which may use a camera device 124 or other sensor to identify people in the vehicle 104. In this example, the audio playback manager 120 receives images captured by the camera device 124 of faces of the people in the vehicle 104. For instance, the camera device 124 captures images of a faces of the first person 202, the second person 204, the third person 206, and the fourth person 208. The person location detection device 122 then applies a facial recognition model to the images of the faces. Based on the facial recognition model, the person location detection device 122 determines identities for the first person 202, the second person 204, the third person 206, and the fourth person 208. Additionally, the audio playback manager 120 may determine which seat or position of the vehicle 104 the first person 202, the second person 204, the third person 206, and the fourth person 208 are located based on additional images or camera angles of images captured inside the vehicle 104 by the camera device 124. For example, an image captured of the first person 202 from a particular angle indicates that the first person 202 is seated in a driver's seat of the vehicle 104.

The vehicle 104 is equipped with a speaker system and a microphone system. In this example, the speaker system includes a first speaker device 108, a second speaker device 110, a third speaker device 210, and a fourth speaker device 212. The speakers of the speaker system receive electrical signals corresponding to audio input 118 and convert the electrical signals into sound. Additionally, in this example, the microphone system includes a first microphone device 112, a second microphone device 114, a third microphone device 214, and a fourth microphone device 216. Although this example includes four speaker devices and four microphone devices, the vehicle 104 may include any number of speaker devices or microphone devices.

The first speaker device 108, the second speaker device 110, the third speaker device 210, and the fourth speaker device 212 may be positioned in doors, a dashboard, a rear deck, headrests, or other positions inside the vehicle to provide a balanced sound system when used together, or a personalized sound system when used separately. Each speaker includes components such as a diaphragm, voice coil, and magnet. An audio signal associated with the audio output 116 passes through the voice coil and creates a magnetic field that interacts with the magnet, causing the diaphragm to vibrate. These vibrations generate sound waves that travel through the air to a person's ears.

The speakers of the speaker system may be positioned inside the vehicle 104 to provide audio output 116 to specific seats of the vehicle 104. For example, particular speakers are located closer to particular seats of the vehicle 104 to direct the audio output 116 toward the particular seats. In this example, the first speaker device 108 is positioned closer to a seat where the first person 202 is located than seats where the second person 204, the third person 206, or the fourth person 208 are located. The second speaker device 110 is positioned closer to a seat where the second person 204 is located than seats where the first person 202, the third person 206, or the fourth person 208 are located. The third speaker device 210 is positioned closer to a seat where the third person 206 is located than seats where the first person 202, second person 204, or the fourth person 208 are located. The fourth speaker device 212 is positioned closer to a seat where the fourth person 208 is located than seats where the first person 202, second person 204, or the third person 206 are located.

Therefore, to personalize an audio consumption experience for people in the vehicle 104, volumes of individual speakers may be adjusted to provide different volumes of the audio output 116 to different people in the vehicle 104. In an additional example implementation, the directions, positions, or other aspects of the individual speakers may be adjusted to provide different concentrations of the audio output 116 to different people in the vehicle 104.

The microphones of the microphone system may also be positioned inside the vehicle 104 to receive audio input 118 from people located at specific seats of the vehicle 104. For example, particular microphones are located closer to particular seats of the vehicle 104 to receive the audio input 118 from the particular seats. In this example, the first microphone device 112 is positioned closer to a seat where the first person 202 is located than seats where the second person 204, the third person 206, or the fourth person 208 are located. The second microphone device 114 is positioned closer to a seat where the second person 204 is located than seats where the first person 202, the third person 206, or the fourth person 208 are located. The third speaker device 210 is positioned closer to a seat where the third person 206 is located than seats where the first person 202, second person 204, or the fourth person 208 are located. The fourth speaker device 212 is positioned closer to a seat where the fourth person 208 is located than seats where the first person 202, second person 204, or the third person 206 are located.

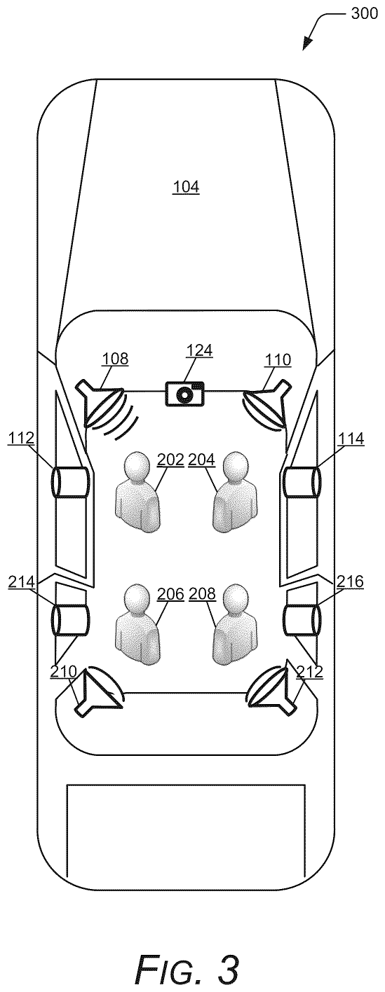

FIG. 3 illustrates example 300 of adjusting audio output in a vehicle by lowering a volume of a speaker device based on a preference related to the audio output. The example 300 is a continuation of the example 200. In this example 300, the audio playback manager 120 lowers the volume of the second speaker device 110, the third speaker device 210, and the fourth speaker device 212 based on audio preferences 132.

To determine which speakers are suitable for volume adjustment, the audio playback manager 120 detects the locations of the first person 202, the second person 204, the third person 206, and the fourth person 208 using the person location detection device 122 described with respect to example 200, which may use the camera device 124 or other sensor to identify the people in the vehicle 104. For example, based on captured images of faces of the people in the vehicle 104, the person location detection device 122 applies a facial recognition model to the faces. Based on the facial recognition model, the person location detection device 122 determines identities for the first person 202, the second person 204, the third person 206, and the fourth person 208. Additionally, the audio playback manager 120 may determine which seat or position of the vehicle 104 the first person 202, the second person 204, the third person 206, and the fourth person 208 are located in based on additional images or camera angles of images captured inside the vehicle 104 by the camera device 124. For example, an image captured of the first person 202 from a particular angle indicates that the first person 202 is seated in a driver's seat of the vehicle 104.

The vehicle 104 in this example implementation is equipped with a first speaker device 108, a second speaker device 110, a third speaker device 210, and a fourth speaker device 212 positioned inside the vehicle 104 to provide audio output 116 to specific seats of the vehicle 104. For example, particular speakers are located closer to particular seats of the vehicle 104 to direct the audio output 116 toward the particular seats. In this example, the first speaker device 108 is positioned closer to a seat where the first person 202 is located than seats where the second person 204, the third person 206, or the fourth person 208 are located. The second speaker device 110 is positioned closer to a seat where the second person 204 is located than seats where the first person 202, the third person 206, or the fourth person 208 are located. The third speaker device 210 is positioned closer to a seat where the third person 206 is located than seats where the first person 202, second person 204, or the fourth person 208 are located. The fourth speaker device 212 is positioned closer to a seat where the fourth person 208 is located than seats where the first person 202, second person 204, or the third person 206 are located.

Therefore, the first speaker device 108, the second speaker device 110, the third speaker device 210, and the fourth speaker device 212 are equipped to playback the audio output 116 throughout the vehicle 104. In some situations, however, the people in the vehicle 104 have different preferences related to the audio output 116. For this reason, the audio playback manager 120 determines preferences for the people in the vehicle 104 and then adjusts volumes of the speaker devices in the vehicle 104 based on the preferences.

To do this, the audio playback manager 120 identifies the audio output 116. Examples of the audio output 116 include music, podcasts, audiobooks, sound effects, radio broadcasts, voice memos and recordings, dialogues and speeches, ambient sounds, live performances, or any other type of audio. Additionally or alternatively, the audio playback manager 120 may classify the identity of the audio output 116 based on any type, classification, genre, artist, band, producer, theme, speaker, lyrics, audience, or other aspect of the audio output 116. The audio playback manager 120 makes this determination of the identity of the audio output 116 based on a label associated with the audio output 116, content of the audio output 116, or any other classifier of the audio output 116. In some example implementations, for example, the audio output 116 leverages a machine learning model trained on identities of different instances of audio content to identify the audio output 116.

In this example, the first speaker device 108, the second speaker device 110, the third speaker device 210, and the fourth speaker device 212 receive the audio output 116 to play inside the vehicle 104. The audio playback manager 120 identifies that the audio output 116 is a jazz song. For example, the audio output 116 includes a tag in metadata associated with the audio output 116 that identifies the audio output 116 as a jazz song.

The audio playback manager 120 then determines the preferences for the first person 202, the second person 204, the third person 206, and the fourth person 208 related to the audio output 116. In one example implementation, the audio playback manager 120 retrieves audio preferences 132 from a database 130 via a communication network 106. The audio preferences 132, for example, may indicate various preferences for a particular person toward various types of audio content corresponding to identities of the audio output 116. In another example implementation, the audio preferences 132 are predetermined, such as based on a questionnaire or manual user input indicating preferences toward various types of audio content. In another example implementation, the audio playback manager 120 uses a machine learning model to determine preferences based on prior audio playback. For instance, the machine learning model is trained on prior interactions with audio content and determines the preferences based on search history, play time, pause history, comments, feedback, or other interactions.

In some example implementations, the audio playback manager 120 determines a preference based on which person requested, streamed or is playing the audio output 116. For example, the audio playback manager 120 may determine that a particular person enjoys the audio output 116 if that person selected the audio output 116 for playback in the vehicle 104. In this example, for instance, the first person 202 selected the jazz song from a playlist using a mobile device associated with the first person 202 and paired with the speakers in the vehicle 104. Therefore, the audio playback manager 120 determines that the preference for the first person 202 toward jazz music is positive.

In this example, the audio playback manager 120 determines that the preference for the first person 202 specifies an appreciation for jazz music. The preference for the second person 204, however, reflects a dislike for jazz music. Additionally, the preference for the third person 206 also indicates a dislike for jazz music. The preference for the third person 206 also reflects a dislike for jazz music.

The audio playback manager 120 then adjusts the volume of the speaker devices based on the preference for the first person 202, the preference for the second person 204, the preference for the third person 206, and the preference for the fourth person 208. In this example, because the preference for the first person 202 is an appreciation for jazz music and the audio output 116 is a jazz song, the audio playback manager 120 retains an initial volume or raises an initial volume of the first speaker device 108 corresponding to the first person 202. Notably, the audio playback manager 120 lowers the initial volume of the second speaker device 110, the third speaker device 210, and the fourth speaker device 212 corresponding to the second person 204, the third person 206, and the fourth person 208 so that the volume of the jazz song heard by the second person 204, the third person 206, and the fourth person 208 is faint. In this way, the people in the vehicle 104 that have a dislike of jazz music are not bothered by the jazz song playing in the vehicle 104.

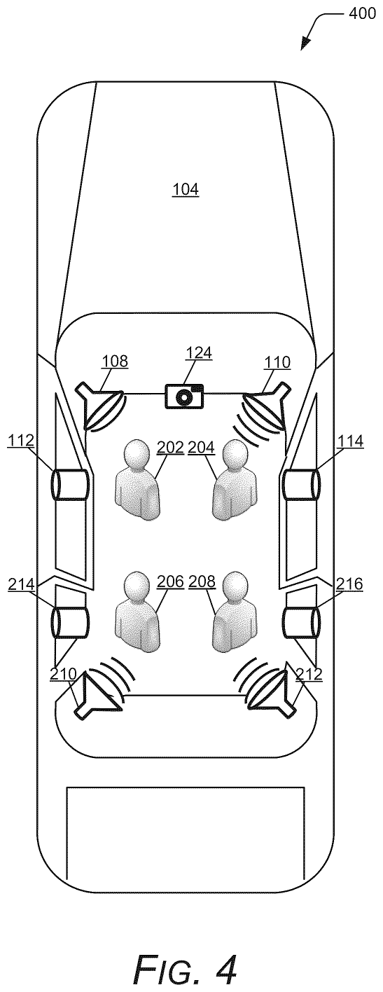

FIG. 4 illustrates example 400 of adjusting audio output in a vehicle by increasing a volume of a speaker device based on a preference related to the audio output. The example 400 is a continuation of the example 300. In this example 400, the audio playback manager 120 lowers the volume of the first speaker device 108 based on audio preferences 132.

As described with respect to FIG. 3 in the example 300, the audio playback manager 120 adjusts the volume of the speaker devices based on the preference for the first person 202, the preference for the second person 204, the preference for the third person 206, and the preference for the fourth person 208. Specifically, because the preference for the first person 202 is an appreciation for jazz music and the audio output 116 is a jazz song, the audio playback manager 120 retains an initial volume or raises an initial volume of the first speaker device 108 corresponding to the first person 202, and the audio playback manager 120 lowers the initial volume of the second speaker device 110, the third speaker device 210, and the fourth speaker device 212 corresponding to the second person 204, the third person 206, and the fourth person 208, respectively. This results in the jazz song being heard faintly by the second person 204, the third person 206, and the fourth person 208.

In this example 400, however, the audio output 116 changes. For example, the jazz song selected by the first person 202 is over, and a country song selected by the second person 204 begins playing inside the vehicle 104. In some implementations, for instance, a change in the audio output 116 automatically prompts the audio playback manager 120 to re-evaluate volumes for the speakers in the vehicle 104.

In this example 400, the first person 202, the second person 204, the third person 206, and the fourth person 208 remain in their respective seats in the vehicle 104. However, in some example implementations the people change positions in the vehicle 104. In response to detecting a change in position of a person in the vehicle 104, the audio playback manager 120 again detects the locations of the first person 202, the second person 204, the third person 206, and the fourth person 208 using the person location detection device 122 described with respect to example 200, which may use the camera device 124 or other sensor to identify the people in the vehicle 104.

As discussed with respect to FIG. 3 in the example 300, the vehicle 104 in this example implementation is equipped with the first speaker device 108, the second speaker device 110, the third speaker device 210, and the fourth speaker device 212 positioned inside the vehicle 104 to provide audio output 116 to specific seats of the vehicle 104. For example, particular speakers are located closer to particular seats of the vehicle 104 to direct the audio output 116 toward the particular seats. In this example, the first speaker device 108 is positioned closer to a seat where the first person 202 is located than seats where the second person 204, the third person 206, or the fourth person 208 are located. The second speaker device 110 is positioned closer to a seat where the second person 204 is located than seats where the first person 202, the third person 206, or the fourth person 208 are located. The third speaker device 210 is positioned closer to a seat where the third person 206 is located than seats where the first person 202, second person 204, or the fourth person 208 are located. The fourth speaker device 212 is positioned closer to a seat where the fourth person 208 is located than seats where the first person 202, second person 204, or the third person 206 are located.

Therefore, the first speaker device 108, the second speaker device 110, the third speaker device 210, and the fourth speaker device 212 are equipped to playback the audio output 116 throughout the vehicle 104. In some situations, however, the people in the vehicle 104 have different preferences related to the audio output 116. For this reason, the audio playback manager 120 determines preferences for the people in the vehicle 104 and then adjusts volumes of the speaker devices in the vehicle 104 based on the preferences.

In this example, the first speaker device 108, the second speaker device 110, the third speaker device 210, and the fourth speaker device 212 receive the audio output 116 to play inside the vehicle 104. The audio playback manager 120 identifies that the audio output 116 is a country song. For example, the audio output 116 includes a tag in metadata associated with the audio output 116 that identifies the audio output 116 as a country song.

The audio playback manager 120 then determines the preferences for the first person 202, the second person 204, the third person 206, and the fourth person 208 related to the audio output 116. As discussed with respect to FIG. 3 in the example 300, the audio playback manager 120 may retrieve audio preferences 132 from a database 130 via a communication network 106. The audio preferences 132, for example, may indicate various preferences for a particular person toward various types of audio content corresponding to identities of the audio output 116. In another example implementation, the audio preferences 132 are predetermined, such as based on a questionnaire or manual user input indicating preferences toward various types of audio content. In another example implementation, the audio playback manager 120 uses a machine learning model to determine preferences based on prior audio playback. For instance, the machine learning model is trained on prior interactions with audio content and determines the preferences based on search history, play time, pause history, comments, feedback, or other interactions.

In some example implementations, the audio playback manager 120 determines a preference based on which person requested, streamed or is playing the audio output 116. For example, the audio playback manager 120 may determine that a particular person enjoys the audio output 116 if that person selected the audio output 116 for playback in the vehicle 104. In this example, for instance, the second person 204 selected the country song from a playlist using a mobile device associated with the first person 202 and paired with the speakers in the vehicle 104. Therefore, the audio playback manager 120 determines that the preference for the second person 204 toward country music is positive.

In this example, the audio playback manager 120 determines that the preference for the second person 204 specifies an appreciation for country music. The preference for the first person 202, however, reflects a dislike for country music. Additionally, the preference for the third person 206 also indicates an appreciation for country music, and the preference for the fourth person 208 also reflects an appreciation for country music.

The audio playback manager 120 then adjusts the volume of the speaker devices based on the preference for the first person 202, the preference for the second person 204, the preference for the third person 206, and the preference for the fourth person 208. In this example, because the preference for the first person 202 is a dislike of country music and the audio output 116 is a country song, the audio playback manager 120 lowers the volume of the first speaker device 108 corresponding to the first person 202. The audio playback manager 120, however, increases the volume of the second speaker device 110, the third speaker device 210, and the fourth speaker device 212 corresponding to the second person 204, the third person 206, and the fourth person 208 so that the volume of the country song heard by the second person 204, the third person 206, and the fourth person 208. In this way, the person in the vehicle 104 that have a dislike of country music are not bothered by the country song playing in the vehicle 104.

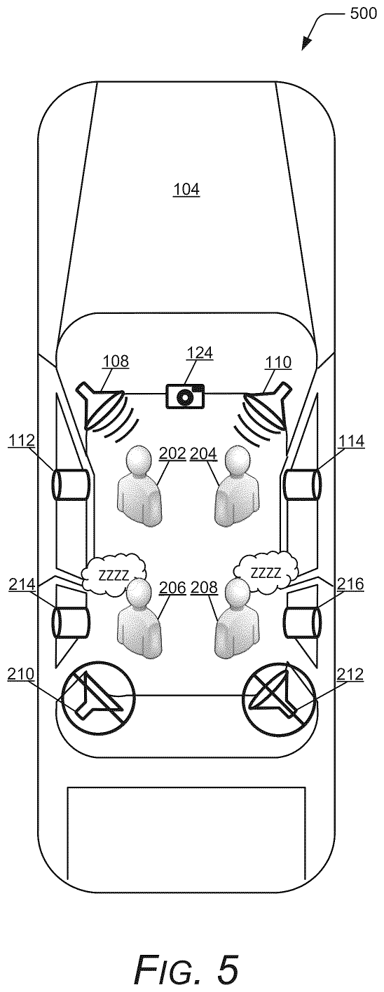

FIG. 5 illustrates example 500 of adjusting audio output in a vehicle by lowering a volume of a speaker device based on detecting whether the person is asleep. The example 500 is a continuation of the example 400. In this example 500, the audio playback manager 120 lowers the volume of the third speaker device 210 and the fourth speaker device 212 based on detecting that the third person 206 and the fourth person 208 are asleep in the vehicle 104.

As described with respect to FIG. 4 in the example 400, the audio playback manager 120 adjusts the volume of the speaker devices based on the preference for the first person 202, the preference for the second person 204, the preference for the third person 206, and the preference for the fourth person 208. Specifically, because the preference for the first person 202 is a dislike of country music and the audio output 116 is a country song, the audio playback manager 120 lowers the volume of the first speaker device 108 corresponding to the first person 202. The audio playback manager 120, however, increases the volume of the second speaker device 110, the third speaker device 210, and the fourth speaker device 212 corresponding to the second person 204, the third person 206, and the fourth person 208 so that the volume of the country song heard by the second person 204, the third person 206, and the fourth person 208.

In this example 400, however, the audio output 116 changes, and the third person 206 and the fourth person 208 fall asleep in the back of the vehicle 104. For example, the country song selected by the second person 204 is over, and a podcast is now playing inside the vehicle 104. In some implementations, for instance, a change in the audio output 116 automatically prompts the audio playback manager 120 to re-evaluate volumes for the speakers in the vehicle 104.

As discussed with respect to FIG. 3 in the example 300, the vehicle 104 in this example implementation is equipped with the first speaker device 108, the second speaker device 110, the third speaker device 210, and the fourth speaker device 212 positioned inside the vehicle 104 to provide audio output 116 to specific seats of the vehicle 104. For example, particular speakers are located closer to particular seats of the vehicle 104 to direct the audio output 116 toward the particular seats. In this example, the first speaker device 108 is positioned closer to a seat where the first person 202 is located than seats where the second person 204, the third person 206, or the fourth person 208 are located. The second speaker device 110 is positioned closer to a seat where the second person 204 is located than seats where the first person 202, the third person 206, or the fourth person 208 are located. The third speaker device 210 is positioned closer to a seat where the third person 206 is located than seats where the first person 202, second person 204, or the fourth person 208 are located. The fourth speaker device 212 is positioned closer to a seat where the fourth person 208 is located than seats where the first person 202, second person 204, or the third person 206 are located.

Therefore, the first speaker device 108, the second speaker device 110, the third speaker device 210, and the fourth speaker device 212 are equipped to playback the audio output 116 throughout the vehicle 104. In some situations, however, the people in the vehicle 104 have different preferences related to the audio output 116. For this reason, the audio playback manager 120 determines preferences for the people in the vehicle 104 and then adjusts volumes of the speaker devices in the vehicle 104 based on the preferences.

In this example, the first speaker device 108, the second speaker device 110, the third speaker device 210, and the fourth speaker device 212 receive the audio output 116 to play inside the vehicle 104. The audio playback manager 120 identifies that the audio output 116 is a podcast. For example, the audio output 116 includes a tag in metadata associated with the audio output 116 that identifies the audio output 116 as a podcast.

The audio playback manager 120 then determines the preferences for the first person 202, the second person 204, the third person 206, and the fourth person 208 related to the audio output 116. In this example, the audio playback manager 120 determines that all the people in the vehicle 104, including the first person 202, the second person 204, the third person 206, and the fourth person 208, have an appreciation for the podcast. The audio playback manager 120 then adjusts the volume of the speaker devices based on the preference for the first person 202, the preference for the second person 204, the preference for the third person 206, and the preference for the fourth person 208.

However, in this example, after listening to the podcast for a few minutes, the third person 206 and the fourth person 208 fall asleep in the back of the vehicle 104. To avoid disturbing sleeping people in the vehicle 104, the audio playback manager 120 detects that a person is sleeping and lowers a volume of a speaker device corresponding to the person.

To do this, the audio playback manager 120 detects that the third person 206 and the fourth person 208 are sleeping. The audio playback manager 120, for example, receives captured images or video of the people in the vehicle 104 from the camera device 124 to detect if any of the people in the vehicle 104 are sleeping. In some example implementations, the audio playback manager 120 uses a machine learning model trained on images or video to determine whether the people in the images or video are sleeping. In some example implementations, the audio playback manager 120 receives an indication manually selected by a person indicating that he or she will try to go to sleep.

In response to detecting that the third person 206 and the fourth person 208 are sleeping, the audio playback manager 120 lowers the volume of the third speaker device 210 and the fourth speaker device 212. Because the third speaker device 210 is directed toward the third person 206 and the fourth speaker device 212 is directed toward the fourth person 208, lowering the volume of the third speaker device 210 and the fourth speaker device 212 prevents awaking the third person 206 and the fourth person 208. For instance, the first speaker device 108 and the second speaker device 110 may be directed toward the first person 202 and the second person 204 in this example and do not disturb the third person 206 and the fourth person 208. Therefore, the first speaker device 108 and the second speaker device 110 remain playing the audio output 116 for enjoyment of the first person 202 and the second person 204.

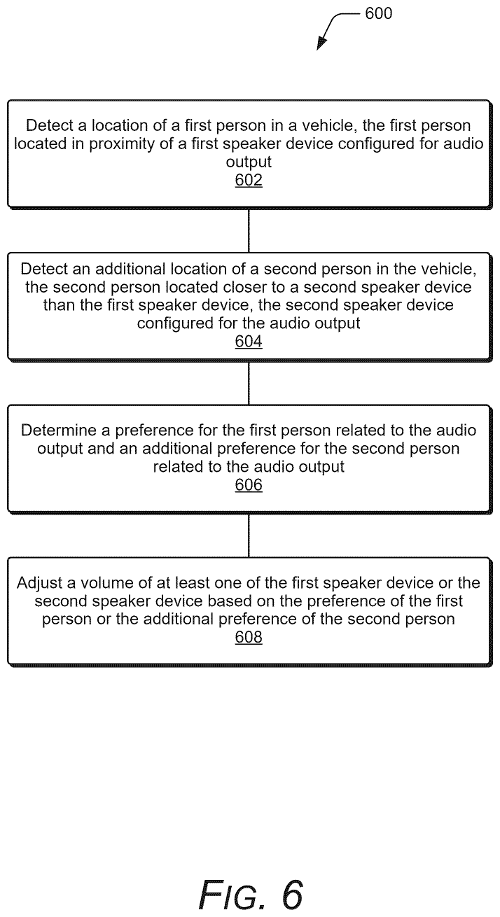

Example methods 600, 700, and 800 are described with reference to respective FIGS. 6, 7, and 8 in accordance with one or more implementations of adjusting audio output in a vehicle, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 6 illustrates example method(s) 600 for adjusting audio output in a vehicle. The order in which the method is described is not intended to be construed as a limitation, and any number or combination of the described method operations may be performed in any order to perform a method, or an alternate method.

At 602, a location of a first person is detected in the vehicle, the first person located in proximity of a first speaker device configured for audio output. For example, the audio playback manager 120 detects a location of a first person 202 in the vehicle 104, the first person 202 located in proximity of a first speaker device 108 configured for audio output 116.

At 604, an additional location of a second person is detected in the vehicle, the second person located closer to a second speaker device than the first speaker device, the second speaker device configured for the audio output. For example, the audio playback manager 120 detects an additional location of a second person 204 in the vehicle 104, the second person 204 located closer to a second speaker device 110 than the first speaker device 108, the second speaker device 110 configured for the audio output 116. In some implementations, the audio playback manager 120 uses facial recognition to detect the location of one or more of first person 202 in the vehicle 104 or the additional location of the second person 204 in the vehicle 104.

At 606, a preference is determined for the first person related to the audio output and an additional preference for the second person related to the audio output. For example, the audio playback manager 120 determines a preference for the first person 202 related to the audio output 116 and an additional preference for the second person 204 related to the audio output 116. In some implementations, the audio playback manager 120 identifies a type of the audio output 116 and determines whether the preference of the first person 202 or the additional preference of the second person 204 is favorable toward the type of the audio output 116.

At 608, a volume of at least one of the first speaker device 108 or the second speaker device 110 is adjusted based on the preference of the first person 202 or the additional preference of the second person 204. For example, the audio playback manager 120 adjusts a volume of at least one of the first speaker device 108 or the second speaker device 110 based on the preference of the first person 202 or the additional preference of the second person 204. In some implementations, the audio playback manager 120 determines whether the first person 202 is asleep and lowers the volume of the first speaker device 108 based on the first person 202 being asleep. In some examples, the preference of the first person 202 or the additional preference of the second person 204 is predetermined based on a user input. Additionally or alternatively, the preference of the first person 202 or the additional preference of the second person 204 is determined by a machine learning model based on prior audio playback. In some implementations, the audio playback manager 120 adjusts the volume of at least one of the first speaker device 108 or the second speaker device 110 in response to a change in the audio output. 116

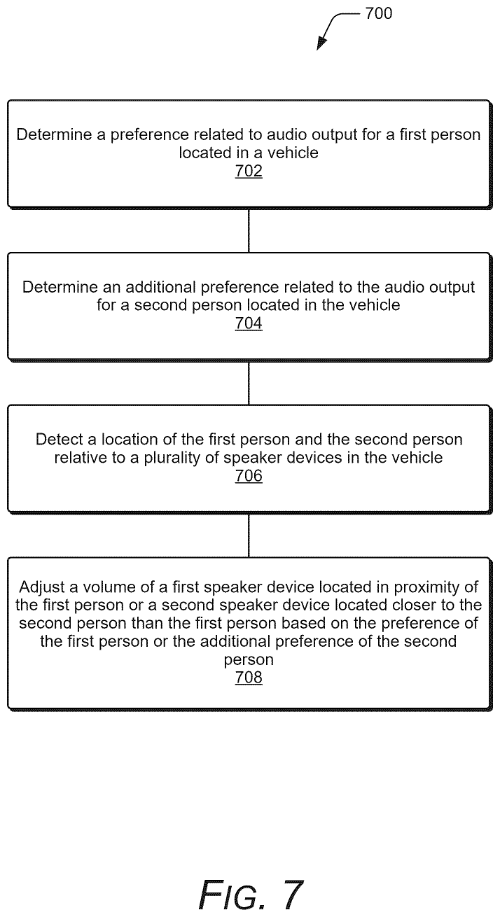

FIG. 7 illustrates example method(s) 700 for adjusting audio output in a vehicle. The order in which the method is described is not intended to be construed as a limitation, and any number or combination of the described method operations may be performed in any order to perform a method, or an alternate method.

At 702, a preference related to audio output for a first person located in a vehicle is determined. For example, the audio playback manager 120 determines a preference related to audio output 116 for a first person 202 located in a vehicle 104.

At 704, an additional preference related to the audio output for a second person located in the vehicle is determined. For example, the audio playback manager 120 determines an additional preference related to the audio output 116 for a second person 204 located in the vehicle. In some implementations, the audio playback manager 120 identifies a type of the audio output 116 and determines whether the preference of the first person 202 or the additional preference of the second person 204 is favorable toward the type of the audio output 116. For example, at least one of the preference of the first person 202 or the additional preference of the second person 204 is predetermined based on a user input. Additionally or alternatively, at least one of the preference of the first person 202 or the additional preference of the second person 204 is determined by a machine learning model based on prior audio playback.

At 706, a location of the first person and the second person relative to a plurality of speaker devices in the vehicle are detected. For example, the audio playback manager 120 detects a location of the first person 202 and the second person 204 relative to a plurality of speaker devices in the vehicle 104. In some implementations, the audio playback manager 120 determines whether the first person 202 is asleep and lowers the volume of the first speaker device 108 based on the first person being asleep. In some implementations, the audio playback manager 120 uses facial recognition to detect the location of one or more of the first person 202 in the vehicle 104 or the location of the second person 204 in the vehicle 104.

At 708, a volume of a first speaker device located in proximity of the first person or a second speaker device located closer to the second person than the first person is adjusted based on the preference of the first person or the additional preference of the second person. For example, the audio playback manager 120 adjusts a volume of a first speaker device 108 located in proximity of the first person 202 or a second speaker device 110 located closer to the second person 204 than the first person 202 based on the preference of the first person 202 or the additional preference of the second person 204. In some implementations, the audio playback manager 120 adjusts the volume of at least one of the first speaker device 108 or the second speaker device 110 in response to a change in the audio output 116.

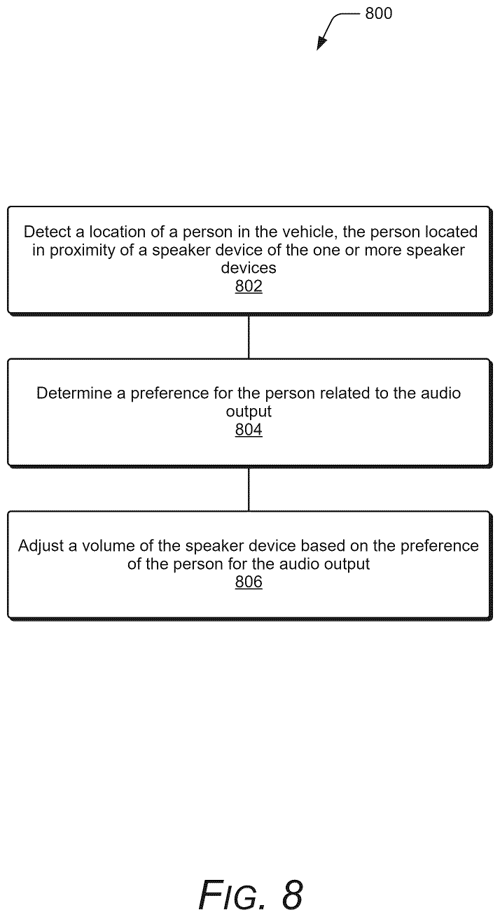

FIG. 8 illustrates example method(s) 800 for adjusting audio output in a vehicle. The order in which the method is described is not intended to be construed as a limitation, and any number or combination of the described method operations may be performed in any order to perform a method, or an alternate method.

At 802, a location of a person in a vehicle is detected, the person located in proximity of a speaker device of one or more speaker devices. For example, the audio playback manager 120 detects a location of a person in a vehicle 104, the person located in proximity of a speaker device of the one or more speaker devices.

At 804, a preference is determined for the person related to audio output. For example, the audio playback manager 120 determines a preference for the person related to audio output 116. In some implementations, the audio playback manager 120 identifies a type of the audio output 116 and determine whether the preference of the person is favorable toward the type of the audio output 116.

At 806, a volume of the speaker device is adjusted based on the preference of the person for the audio output. For example, the audio playback manager 120 adjusts a volume of the speaker device based on the preference of the person for the audio output 116. In some implementations, the audio playback manager 120 determines whether the person is asleep and to lower the volume of the speaker device based on the person being asleep. In some implementations, the audio playback manager 120 further adjusts the volume of the speaker device in response to a change in the audio output 116.

FIG. 9 illustrates various components of an example device 900, which can implement aspects of the techniques and features for adjusting audio output in a vehicle, as described herein. The example device 900 may be implemented in a vehicle and/or as any of the devices described with reference to the previous FIGS. 1-8, such as any type of a wireless device, mobile device, mobile phone, flip phone, client device, companion device, display device, tablet, computing, communication, entertainment, gaming, media playback, and/or any other type of computing and/or electronic device. For example, the vehicle audio system 102 described with reference to FIGS. 1-8 may be implemented as the example device 900.

The example device 900 can include various, different communication devices 902 that enable wired and/or wireless communication of device data 904 with other devices. The device data 904 can include data from any of the various devices and content that is generated, processed, determined, received, stored, and/or communicated from one computing device to another. Generally, the device data 904 can include any form of audio, video, image, graphics, and/or electronic data that is generated by applications executing on a device. The communication devices 902 can also include transceivers for cellular phone communication and/or for any type of network data communication.

The example device 900 can also include various, different types of data input/output (I/O) interfaces 906, such as data network interfaces that provide connection and/or communication links between the devices, data networks, and other devices. The data I/O interfaces 906 may be used to couple the device to any type of components, peripherals, and/or accessory devices, such as a computer input device that may be integrated with the example device 900. The I/O interfaces 906 may also include data input ports via which any type of data, information, media content, communications, messages, and/or inputs may be received, such as user inputs to the device, as well as any type of audio, video, image, graphics, and/or electronic data received from any content and/or data source.

The example device 900 includes a processor system 908 of one or more processors (e.g., any of microprocessors, controllers, and the like) and/or a processor and memory system implemented as a system-on-chip (SoC) that processes computer-executable instructions. The processor system 908 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 910. The example device 900 may also include any type of a system bus or other data and command transfer system that couples the various components within the device. A system bus can include any one or combination of different bus structures and architectures, as well as control and data lines.

The example device 900 also includes memory and/or memory devices 912 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 912 include volatile memory and non-volatile memory, fixed and removable media devices, and any suitable memory device or electronic data storage that maintains data for computing device access. The memory devices 912 can include various implementations of random-access memory (RAM), read-only memory (ROM), flash memory, and other types of storage media in various memory device configurations. The example device 900 may also include a mass storage media device.

The memory devices 912 (e.g., as computer-readable storage memory) provide data storage mechanisms, such as to store the device data 904, other types of information and/or electronic data, and various device applications 914 (e.g., software applications and/or modules). For example, an operating system 916 may be maintained as software instructions with a memory device 912 and executed by the processor system 908 as a software application. The device applications 914 may also include a device manager, such as any form of a control application, software application, signal-processing and control module, code that is specific to a particular device, a hardware abstraction layer for a particular device, and so on.

In this example, the device 900 includes an audio playback manager 918 that implements various aspects of the described features and techniques described herein. The audio playback manager 918 may be implemented with hardware components and/or in software as one of the device applications 914, such as when the example device 900 is implemented as the vehicle audio system 102 described with reference to FIGS. 1-8. An example of the audio playback manager 918 is the audio playback manager 120 implemented by the vehicle audio system 102, such as a software application and/or as hardware components in the mobile device. In implementations, the audio playback manager 918 may include independent processing, memory, and logic components as a computing and/or electronic device integrated with the example device 900.

The example device 900 can also include a microphone 920 and/or camera devices 922, as well as device sensors 924, such as may be implemented as components of an inertial measurement unit (IMU). The device sensors 924 may be implemented with various sensors, such as a gyroscope, an accelerometer, and/or other types of motion sensors to sense motion of the device. The device sensors 924 can generate sensor data vectors having three-dimensional parameters (e.g., rotational vectors in x, y, and z-axis coordinates) indicating location, position, acceleration, rotational speed, and/or orientation of the device. The example device 900 can also include one or more power sources 926, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 900 can also include an audio and/or video processing system 928 that generates audio data for an audio system 930 and/or generates display data for a display system 932. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 900. Alternatively, the audio system and/or the display system are external, peripheral components to the example device.

Although implementations for adjusting audio output in a vehicle have been described in language specific to features and/or methods, the appended claims are not necessarily limited to the specific features or methods described. Rather, the specific features and methods are disclosed as example implementations for adjusting audio output in a vehicle, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a vehicle audio system, including: at least one memory, and at least one processor coupled with the at least one memory and configured to cause the vehicle audio system in a vehicle to: detect a location of a first person in the vehicle, the first person located in proximity of a first speaker device configured for audio output, detect an additional location of a second person in the vehicle, the second person located closer to a second speaker device than the first speaker device, the second speaker device configured for the audio output, determine a preference for the first person related to the audio output and an additional preference for the second person related to the audio output, and adjust a volume of at least one of the first speaker device or the second speaker device based on the preference of the first person or the additional preference of the second person.

In some aspects, the techniques described herein relate to a vehicle audio system, wherein the at least one processor is configured to cause the vehicle audio system to identify a type of the audio output and determine whether the preference of the first person or the additional preference of the second person is favorable toward the type of the audio output.

In some aspects, the techniques described herein relate to a vehicle audio system, wherein the at least one processor is configured to determine whether the first person is asleep.

In some aspects, the techniques described herein relate to a vehicle audio system, wherein the at least one processor is configured to cause the vehicle audio system to lower the volume of the first speaker device based on the first person being asleep.

In some aspects, the techniques described herein relate to a vehicle audio system, wherein the at least one processor is configured to cause the vehicle audio system to use facial recognition to detect the location of one or more of the first person in the vehicle or the additional location of the second person in the vehicle.

In some aspects, the techniques described herein relate to a vehicle audio system, wherein the preference of the first person or the additional preference of the second person is predetermined based on a user input.

In some aspects, the techniques described herein relate to a vehicle audio system, wherein the preference of the first person or the additional preference of the second person is determined by a machine learning model based on prior audio playback.

In some aspects, the techniques described herein relate to a vehicle audio system, wherein the at least one processor is configured to cause the vehicle audio system to further adjust the volume of at least one of the first speaker device or the second speaker device in response to a change in the audio output.

In some aspects, the techniques described herein relate to a method, including: determining a preference related to audio output for a first person located in a vehicle, determining an additional preference related to the audio output for a second person located in the vehicle, detecting a location of the first person and the second person relative to a plurality of speaker devices in the vehicle, and adjusting a volume of a first speaker device located in proximity of the first person or a second speaker device located closer to the second person than the first person based on the preference of the first person or the additional preference of the second person.

In some aspects, the techniques described herein relate to a method, further including identifying a type of the audio output and determining whether the preference of the first person or the additional preference of the second person is favorable toward the type of the audio output.

In some aspects, the techniques described herein relate to a method, further including determining whether the first person is asleep.

In some aspects, the techniques described herein relate to a method, further including lowering the volume of the first speaker device based on the first person being asleep.

In some aspects, the techniques described herein relate to a method, further including using facial recognition to detect the location of the first person in the vehicle or the location of the second person in the vehicle.

In some aspects, the techniques described herein relate to a method, wherein at least one of the preference of the first person or the additional preference of the second person is predetermined based on a user input.

In some aspects, the techniques described herein relate to a method, wherein at least one of the preference of the first person or the additional preference of the second person is determined by a machine learning model based on prior audio playback.

In some aspects, the techniques described herein relate to a method, further including adjusting the volume of at least one of the first speaker device or the second speaker device in response to a change in the audio output.

In some aspects, the techniques described herein relate to a system, including: one or more speaker devices in a vehicle, the one or more speaker devices configured for audio output, and a processor configured to implement an audio playback manager to: detect a location of a person in the vehicle, the person located in proximity of a speaker device of the one or more speaker devices, determine a preference for the person related to the audio output, and adjust a volume of the speaker device based on the preference of the person for the audio output.

In some aspects, the techniques described herein relate to a system, wherein the audio playback manager is configured to identify a type of the audio output and determine whether the preference of the person is favorable toward the type of the audio output.

In some aspects, the techniques described herein relate to a system, wherein the audio playback manager is configured to cause the vehicle audio system to determine whether the person is asleep and to lower the volume of the speaker device based on the person being asleep.

In some aspects, the techniques described herein relate to a system, wherein the audio playback manager is configured to further adjust the volume of the speaker device in response to a change in the audio output.

1. A vehicle audio system, comprising:
at least one memory; and
at least one processor coupled with the at least one memory and configured to cause the vehicle audio system in a vehicle to:
detect a location of a first person in the vehicle, the first person located in proximity of a first speaker device configured for audio output;
detect an additional location of a second person in the vehicle, the second person located closer to a second speaker device than the first speaker device, the second speaker device configured for the audio output;
determine a preference for the first person related to the audio output and an additional preference for the second person related to the audio output; and
adjust a volume of at least one of the first speaker device or the second speaker device based on the preference of the first person or the additional preference of the second person.

2. The vehicle audio system of claim 1, wherein the at least one processor is configured to cause the vehicle audio system to identify a type of the audio output and determine whether the preference of the first person or the additional preference of the second person is favorable toward the type of the audio output.

3. The vehicle audio system of claim 1, wherein the at least one processor is configured to cause the vehicle audio system to determine whether the first person is asleep.

4. The vehicle audio system of claim 3, wherein the at least one processor is configured to cause the vehicle audio system to lower the volume of the first speaker device based on the first person being asleep.

5. The vehicle audio system of claim 1, wherein the at least one processor is configured to cause the vehicle audio system to use facial recognition to detect the location of the first person in the vehicle or the additional location of the second person in the vehicle.

6. The vehicle audio system of claim 1, wherein the preference of the first person or the additional preference of the second person is predetermined based on a user input.

7. The vehicle audio system of claim 1, wherein the preference of the first person or the additional preference of the second person is determined by a machine learning model based on prior audio playback.

8. The vehicle audio system of claim 1, wherein the at least one processor is configured to cause the vehicle audio system to further adjust the volume of at least one of the first speaker device or the second speaker device in response to a change in the audio output.

9. A method, comprising:
determining a preference related to audio output for a first person located in a vehicle;
determining an additional preference related to the audio output for a second person located in the vehicle;
detecting a location of the first person and the second person relative to a plurality of speaker devices in the vehicle; and
adjusting a volume of a first speaker device located in proximity of the first person or a second speaker device located closer to the second person than the first person based on the preference of the first person or the additional preference of the second person.

10. The method of claim 9, further comprising identifying a type of the audio output and determining whether the preference of the first person or the additional preference of the second person is favorable toward the type of the audio output.

11. The method of claim 9, further comprising determining whether the first person is asleep.

12. The method of claim 11, further comprising lowering the volume of the first speaker device based on the first person being asleep.

13. The method of claim 9, further comprising using facial recognition to detect the location of one or more of the first person in the vehicle or the location of the second person in the vehicle.

14. The method of claim 9, wherein at least one of the preference of the first person or the additional preference of the second person is predetermined based on a user input.

15. The method of claim 9, wherein at least one of the preference of the first person or the additional preference of the second person is determined by a machine learning model based on prior audio playback.

16. The method of claim 9, further comprising adjusting the volume of at least one of the first speaker device or the second speaker device in response to a change in the audio output.

17. A system, comprising:
one or more speaker devices in a vehicle, the one or more speaker devices configured for audio output; and
a processor configured to implement an audio playback manager to:
detect a location of a person in the vehicle, the person located in proximity of a speaker device of the one or more speaker devices;
determine a preference for the person related to the audio output; and
adjust a volume of the speaker device based on the preference of the person for the audio output.

18. The system of claim 17, wherein the audio playback manager is configured to identify a type of the audio output and determine whether the preference of the person is favorable toward the type of the audio output.

19. The system of claim 17, wherein the audio playback manager is configured to determine whether the person is asleep and to lower the volume of the speaker device based on the person being asleep.

20. The system of claim 19, wherein the audio playback manager is configured to further adjust the volume of the speaker device in response to a change in the audio output.
